(19) United States
(12) Patent Application Publication
(10) Pub. No.: US 2011/0308696 A1
(43) Pub. Date: Dec. 22, 2011

(54) METHOD AND APPARATUS FOR CREATING AND CONNECTING PAPER SHAPES WITH QUILLED PAPER

(76) Inventor: Raymond Suskin, Kadima, IL (US)

(21) Appl. No.: 13/038,822

(22) Filed: Mar. 2, 2011

Related U.S. Application Data
(60) Provisional application No. 61/356,269, filed on Jun. 18, 2010.

(51) Int. Cl. B44C 3/12; B65H 19/28; B65H 35/00; B32B 37/16

(52) U.S. Cl. 156/63; 156/436; 242/532.6; 242/526; 242/539

(57) ABSTRACT

A device for paper quilling is provided, including a turning device with a cavity, a fixed spindle displaced from the turning device, a rewinding spindle with a slot and a connector base, where the connector base is shaped to fit into the shaped cavity so that part of the rewinding spindle sits above the cavity and the rewinding spindle rotates when the turning device rotates.

### CROSS-REFERENCE TO RELATED APPLICATION

This application claims priority on the basis of provisional patent application No. 61/356,269, filed on Jun. 18, 2010. The entire disclosure of the provisional patent application is incorporated herein by this reference.

### FIELD OF INVENTION

The present invention relates generally to the field of quilling devices, particularly quilling toys. In particular, the invention relates to the field of an apparatus for paper quilling and a method of assembling a rolled paper material.

### BACKGROUND

Quilling or paper filigree is an art form that involves the use of strips of paper that are rolled, shaped, and glued together to create decorative designs. The paper is wound around a quill to create a basic coil shape. The paper is then glued at the tip and the coil shaped. The shaped coils can be arranged to form flowers, leaves, and various other patterns similar to ironwork.

During the Renaissance, French and Italian nuns and monks used quilling to decorate book covers and religious items. The paper most commonly used was strips of paper trimmed from the gilded edges of books. These gilded paper strips were then rolled to create the quilled shapes. Quilling often imitated the original ironworks of the day.

In the 18^{th} century, quilling became popular in Europe where gentle ladies of quality practiced the art. It was one of the few things ladies could do that was thought not too taxing for their minds or gentle dispositions. Quilling also spread to the Americans and there are a few examples from Colonial times.

To date “Paper Filigree” or “Quilling” is seen as an art/craft item targeting a relatively small niche market of mainly adults. In existing similar applications the paper is simply rolled manually. This is not a simple process, especially for small children as constant tension of the roll needs to be maintained and the roll will unravel if left before the process is complete. This may make quilling difficult for people with reduced manual coordination, such as children.

### BRIEF SUMMARY

In accordance with one embodiment, a device for paper quilling includes a turning device with a cavity, a fixed spindle displaced from the turning device, a rewinding spindle with a slot and a connector base, where the connector base is shaped to fit into the shaped cavity so that part of the rewinding spindle sits above the cavity and the rewinding spindle rotates when the turning device rotates.

In accordance with another embodiment, a method for paper quilling includes placing a bulk roll on a fixed spindle, placing a rewinding spindle into a cavity connected to a turning mechanism, feeding an end of the bulk roll into a slot on the rewinding spindle, and rotating the turning mechanism causing paper from the bulk roll to wrap around the rewinding spindle forming a rewinding roll.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The features and advantages of embodiments of the present invention can be understood by reference to the following detailed description taken with the following figures of embodiments of the invention.

FIG. 1 depicts an exemplary winding device and accessories for paper quilling;

FIG. 2 depicts an exemplary step in a procedure for paper quilling;

FIG. 3 depicts another exemplary step in a procedure for paper quilling;

FIG. 4 depicts another exemplary step in a procedure for paper quilling;

FIG. 5 depicts another exemplary step in a procedure for paper quilling;

FIG. 6 depicts another exemplary step in a procedure for paper quilling;

FIG. 7 depicts another exemplary step in a procedure for paper quilling;

FIG. 8 depicts another exemplary step in a procedure for paper quilling;

FIG. 9 depicts another exemplary step in a procedure for paper quilling;

FIG. 10 depicts another exemplary step in a procedure for paper quilling;

FIG. 11 depicts an alternative exemplary step in a procedure for paper quilling with more than one bulk roll;

FIG. 12 depicts another alternative exemplary step in a procedure for paper quilling with more than one bulk roll;

FIG. 13 depicts another alternative exemplary step in a procedure for paper quilling with more than one bulk roll;

FIG. 14 depicts a flowchart for an exemplary procedure for paper quilling;

FIG. 15 depicts a flowchart for an exemplary procedure for covering a skeleton with a rewinding roll;

FIG. 16 depicts exemplary skeletons and an exemplary accessory connector for paper quilling;

FIG. 17 depicts exemplary steps in a procedure for covering a skeleton with a rewinding roll;

FIGS. 18a-c depicts exemplary connections between skeletons, spindles, and connectors;

FIGS. 19a-b depict an exemplary figure constructed through the connection of paper shapes;

FIG. 20 depicts an exemplary machine for paper quilling;

FIGS. 21a-e depicts exemplary small machines for paper quilling; and

FIG. 22 depicts an exemplary large winding device for paper quilling.

### DETAILED DESCRIPTION

For the purposes of promoting an understanding of the principles of the invention, reference will now be made to certain preferred embodiments thereof and specific language will be used to describe the same. It will nevertheless be understood that no limitation of the scope of the invention is thereby intended, such alterations, further modifications, and applications for the principles of the invention as described herein being contemplated as would normally occur to one skilled in the art to which the invention relates.

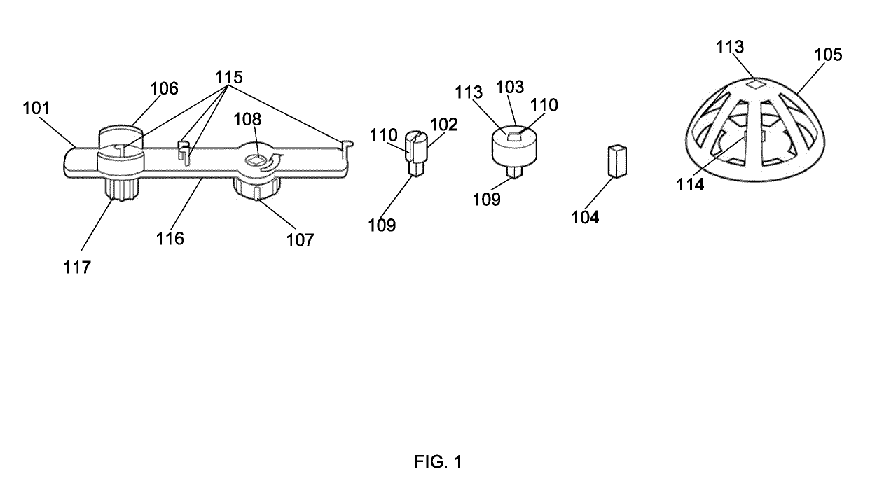

FIG. 1 depicts an exemplary winding device and accessories for paper quilling. A winding device 101 may include a body 116, a grip 117, a fixed spindle 106, a winding knob 107, a cavity 108, and several rubber band holders 115. Accessories for use with the winding device 101 may include a small spindle 102, a large spindle 103, a connector 104, and a skeleton 105.

The winding device 101 may be a device for paper quilling. The body 116 of the winding device 101 may be made from any suitable material, such as, for example, plastic, and may be any suitable length, width, and thickness for paper quilling. The fixed spindle 106 may be attached at one end of the body 116, may protrude above the body 116, and may be, for example, part of the body 116, or may be a separate piece or pieces attached to the body 116. The fixed spindle 106 may be fully circular piece, or may be, as depicted in FIG. 1, separate portions of a circle. The grip 117 may be attached to the body 116 below the fixed spindle 106, and may be any suitable size, shape, and material, to allow a person to grip the winding device 101.

The winding knob 107 may be attached at the other end of the body 116 from the fixed spindle 106 and the grip 117, and on the same side of the body as the grip 117. The cavity 108 may be attached to the winding knob 107. The open part of the cavity 108 may be accessible on the other side of the body 116 from the winding knob 107 through a hole in the body 116. The winding knob 107 may be any suitable size and shape to allow for the rotation of the winding knob 107. The cavity 108 may rotate when the winding knob 107 is rotated.

The rubber band holders 115 may be protrusions from the body 116 of the winding device 101 in any suitable shape to hold in place a rubber band strung between two of the rubber band holders 115. For example, the rubber band holders 115 may be arranged so that one rubber band may be held over the fixed spindle 106, and another rubber band may be held over the cavity 108. For example, one rubber band holder 115 may be located in the center of the fixed spindle 106, two rubber band holders 115 may be located in between the fixed spindle 106 and the cavity 108, and another rubber band holder 115 may be located on or near the edge of the body 116 nearest to the cavity 108.

The small spindle 102 and the large spindle 103 may be accessories for the winding device 101 that may be used in paper quilling. The small spindle 102 may be made of any suitable material, such as, for example, plastic, and in any number of parts, and may include a connector base 109 and a slot 110. The connector base 109 may be shaped to fit into the cavity 108 on the winding device 101. For example, if the cavity 108 is box shaped, the connector base 109 may have a box shape, sized so that when the connector base 109 is inserted into the cavity 108, the rest of the small spindle 102 remains above the cavity 108. The slot 110 may be an opening in the small spindle 102 above the connector base 109, which may be sized and shaped to receive the end of any suitable type of paper used in paper quilling. The slot 110 may split the upper part of the small spindle 102 in half, or may only go partway through the small spindle 102.

The large spindle 103 may be made of any suitable material, such as, for example, plastic, and may include the connector base 109, the slot 110, and a cavity 113. The connector base 109 may be the same as in the small spindle 102. The large spindle 103 may have a larger portion above the connector base than the small spindle 102, and the slot 110 may only go partway through the large spindle 103. The cavity 113 may be of the same size and shape as the cavity 108, and may be located in the upper portion of the large spindle 103. The cavity 113 may be able to receive the connector base 109 in the same manner as the cavity 108.

The connector 104 may be made of any suitable material, such as, for example, plastic, and may be the same size and shape as two connector bases 109 put together. The connector 104 may be able to fit in the cavity 113 on either end, and may be able to accept one cavity 113 on one end, and another cavity 113 on the other end, allowing for two pieces with the cavity 113 to be connected together.

The skeleton 105 may be made of any suitable material, such as, for example, plastic, and may include the cavity 113 and the bottom cavity 114. The bottom cavity 114 may be of the same size and shape as the cavity 113, and may be located opposite the cavity 113. The skeleton 105 may be domed shaped, and may include ribs as a support structure radiating from the top of the skeleton, where the cavity 113 may be located, to the base of the skeleton. The skeleton 105 may also be formed in other shapes that are not domes, though they maintain the ribbed structure, as shown in FIG. 16. The skeleton 105 may be pre-coated with an adhesive to allow paper rolled over the skeleton 105 to be attached more securely.

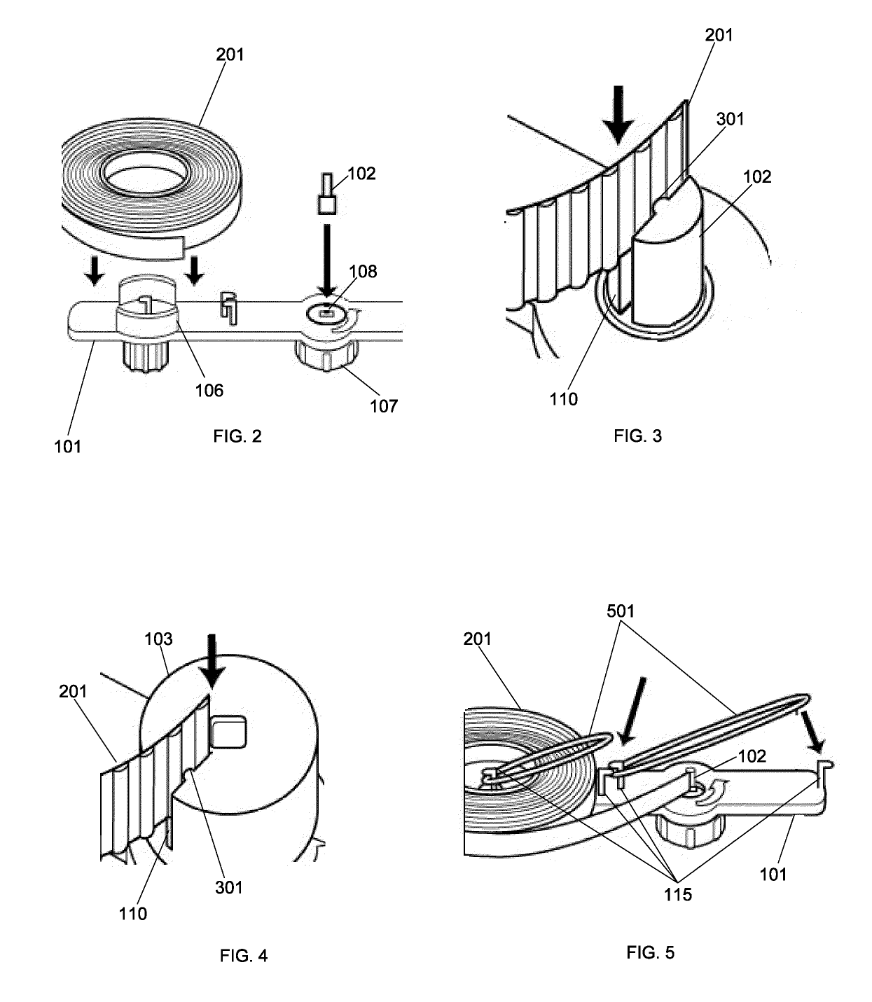

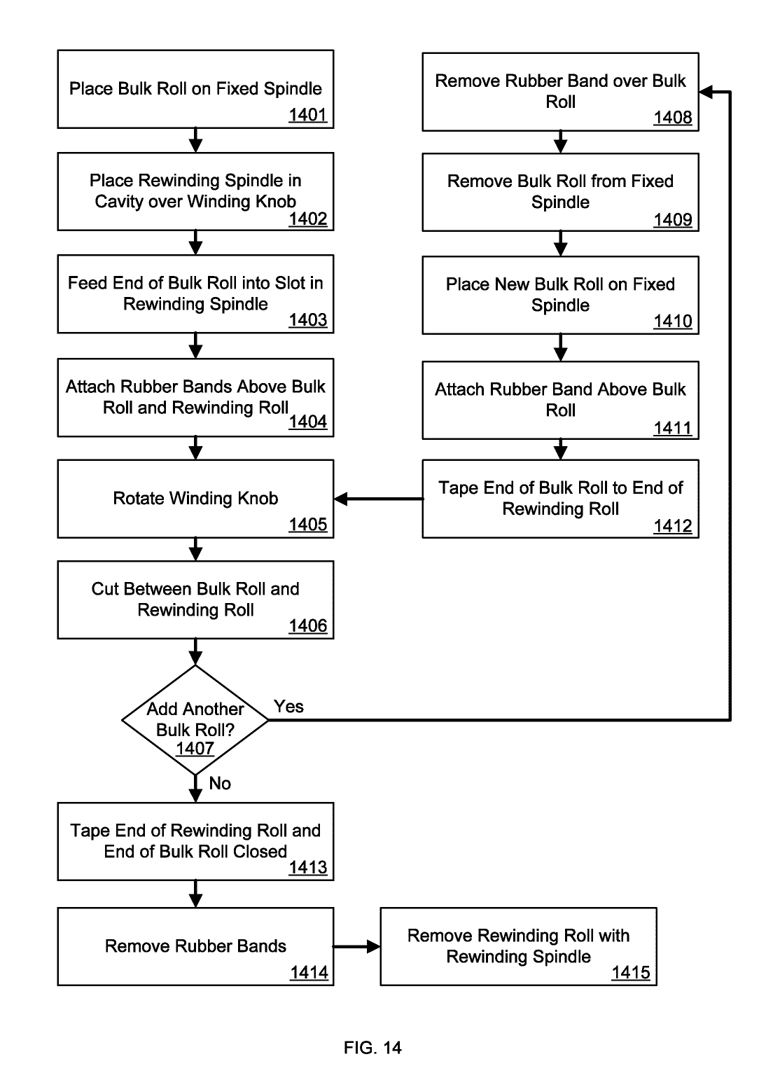

FIG. 14 depicts a flowchart for an exemplary procedure for paper quilling. In block 1401, a bulk roll may be placed on a fixed spindle of a winding device. As depicted in FIG. 2, a bulk roll 201 may be placed on the fixed spindle 106 of the winding device 101. The bulk roll 201 may include paper, such as, for example, any color and grade of corrugated paper or heavy grade crepe paper, pre-rolled onto a paper or plastic cores. The paper of the bulk roll 201 may be, for example, a 10 mm wide, 3 to 6 meter long strip, and the paper core may be 3.5 cm in diameter. When the bulk roll 201 is placed on the fixed spindle 106, the bulk roll 201 may be able to rotate freely around the fixed spindle 106, or there may be an increased amount of friction between the bulk roll 201 and the fixed spindle 106 in order to increase the tension of the paper as it is being rewound.

In block 1402, a rewinding spindle may be placed in the cavity of a winding device over a winding knob. For example, the small spindle 102 or the large spindle 103 may serve as the rewinding spindle, and may be inserted in the cavity 108 of the winding device 101. As depicted in FIG. 1, the connector base 109 of the small spindle 102 may be inserted into the cavity 108.

In block 1403, the end of the bulk roll may be fed into the slot on the rewinding spindle. For example, as depicted in FIG. 3, the end of the bulk roll 201 may be fed into the slot 110 on the small spindle 102. The small spindle 102 may include a tooth 301 on the slot 110 to secure the end of the bulk roll 201. If the large spindle 103 is used as the rewinding spindle, the end of the bulk roll 201 may be fed into the large spindle 103 as depicted in FIG. 4. Inserting the end of the bulk roll 201 in the rewinding spindle may form the start of a rewinding roll 501. The rewinding roll 501 may be the roll of paper formed with the transfer of paper from the bulk roll 201 to the rewinding spindle.

In block 1404, rubber bands may be attached above the bulk roll and the rewinding roll. For example, one rubber band 502 may be attached to the winding device 101 between the rubber band holder 115 in the middle of the fixed spindle 106 and one of the rubber band holders 115 in between the fixed spindle 106 and the cavity 108. This rubber band 502 may maintain tension on the bulk roll 201, ensuring the paper spools out evenly and the bulk roll 201 does not become unwound. Another rubber band 502 may be attached between another rubber band holder 115 in between the fixed spindle 106 and the cavity 108, and the rubber band holder 115 between the edge of the winding device 101 and the cavity 108. This rubber band 502 may maintain tension on the rewinding roll 501.

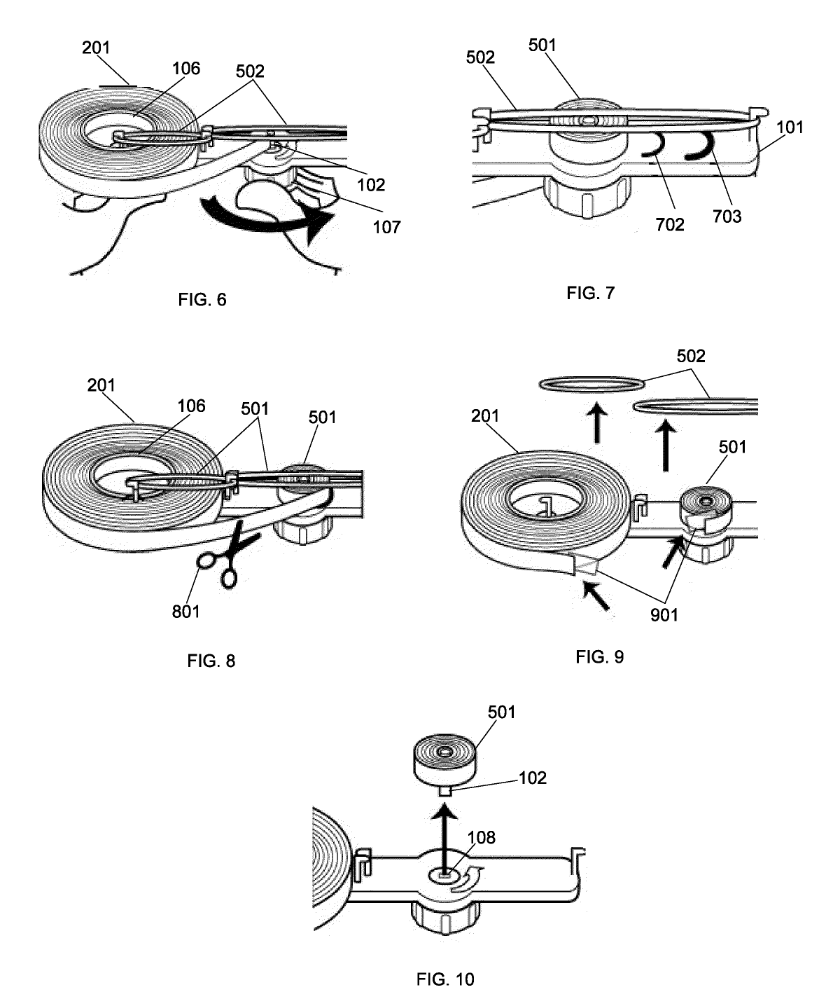

In block 1405, the winding knob may be rotated. As depicted in FIG. 6, a user may grip the winding device 101 using the grip 117 and the winding knob 107. The user may rotate the winding knob 107, causing paper from the bulk roll 201 to be wound around the rewinding spindle, resulting in the rewinding roll 501. As the winding knob 107 is turned, more paper may be wound around the rewinding spindle, causing the rewinding roll 501 to increase in size, as depicted in FIG. 7. The winding device 101 may include size markings 702 and 703, on the body 116, for example, between the cavity 108 and the edge of the winding device 101. The size markings 702 and 703 may be used to judge the size of the rewinding roll 501. For example, a rewinding roll 501 that covers the size marking 702 may be a small rewinding roll, and a rewinding roll 501 that cover the size marking 703 may be a large rewinding roll. The user may use the size markings 702 and 703 to determine when to stop rotating the winding knob 107.

In block 1406, the paper may be cut between the bulk roll and the rewinding roll. For example, as depicted in FIG. 8, a cutting device 801 may be used to cut the paper in between the bulk roll 201 and the rewinding roll 501. The cutting device 801 may be, for example, a pair of scissors.

In block 1407, the user may decide whether to use another bulk roll to add another type of paper to the rewinding roll. If another bulk roll is added, flow proceeds to block 1408, otherwise flow proceeds to block 1413.

In block 1408, the rubber band over the bulk roll may be removed. For example, the rubber band 502 over the bulk roll 201 may be removed from the winding device 101.

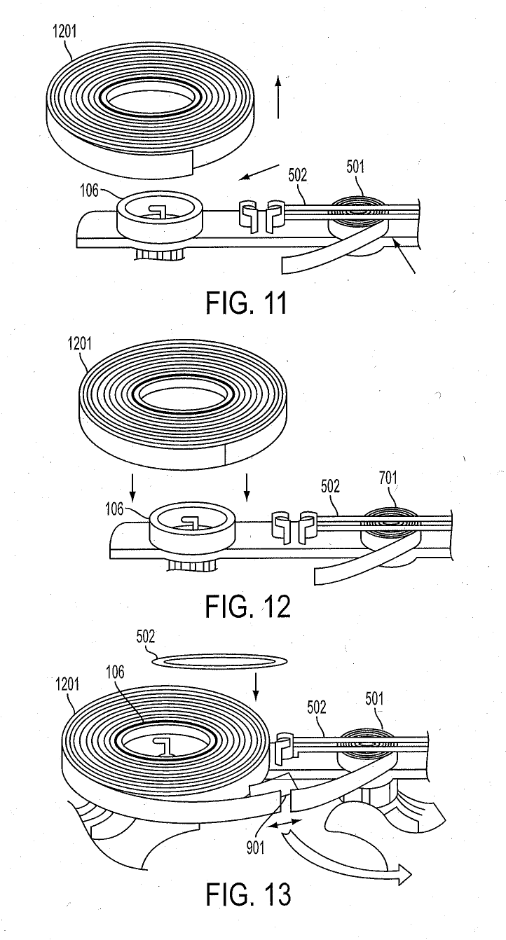

In block 1409, the bulk roll may be removed from the fixed spindle. As depicted in FIG. 11, the bulk roll 201 may be lifted off of the fixed spindle 106, removing the bulk roll 201 from the winding device 101, while the rewinding roll 501 may be left in place.

In block 1410, a new bulk roll may be placed on the fixed spindle. New bulk roll 1201 may be similar to the bulk roll 201, but may include, for example, a different color or grade of paper. The new bulk roll 1201 may be placed on the fixed spindle 106 of the winding device 101, as depicted in FIG. 12

In block 1411, the rubber band may be replaced over the new bulk roll. For example, as depicted in FIG. 13, the rubber band 502 that was removed from over the bulk roll 201 may be replaced over the new bulk roll 1201, as in block 1404.

In block 1412, the end of the new bulk roll may be taped to the end of the rewinding roll. For example, as depicted in FIG. 13, the end of the new bulk roll 1201 may be taped to the end of the rewinding roll 501 using tape 901. This may establish continuity between the new bulk roll 1201 and the rewinding roll 501, allowing paper from the new bulk roll 1201 to be wound onto the rewinding roll 501.

After block 1412, flow may proceed back to block 1405, where the winding knob 107 may be rotated to transfer paper from the new bulk roll 1201 to the rewinding roll 501 until the rewinding roll 501 has reached the size desired by the user. Additional bulk rolls may then be added, as per blocks 1406 and 1407.

In block 1413, the end of the bulk roll and the end of the rewinding roll may be taped close. For example, as depicted in FIG. 9, pieces of tape 901 may be used to tape the end of the bulk roll 201 down to the rest of the bulk roll 201, and the end of the rewinding roll 501 down to the rest of the rewinding roll 501. Any other suitable adhesive material may be used in place of the pieces of tape 901.

In block 1414, the rubber bands may be removed from the winding device. For example, as depicted in FIG. 9, both of the rubber bands 502 may be removed from above the bulk roll 201 and the rewinding roll 501.

In block 1415, the rewinding roll may be removed from the winding device. For example, as depicted in FIG. 10, the rewinding roll 501 may removed from the winding device 101 by lifting the rewinding roll 501, including the rewinding spindle, out of the cavity 108.

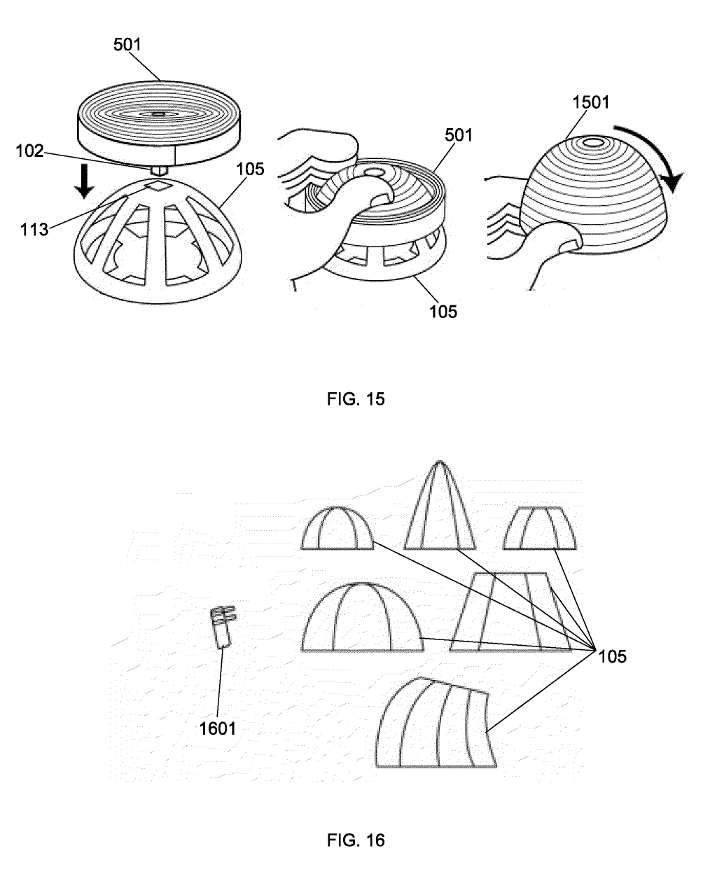

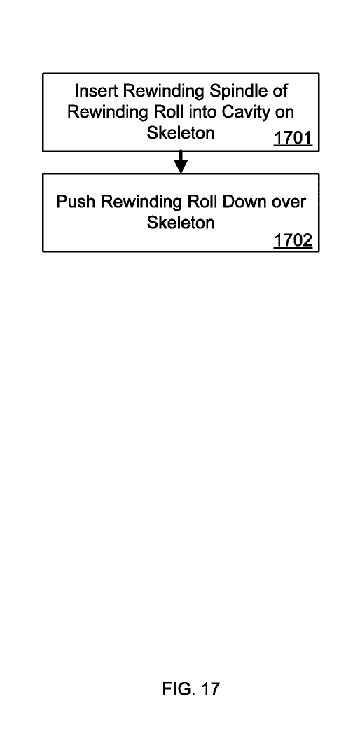

FIG. 17 depicts a flowchart for an exemplary procedure for covering a skeleton with a rewinding roll. FIG. 15 depicts exemplary steps in a procedure for covering a skeleton with a rewinding roll. In block 1701, the connector base of the rewinding spindle may be inserted into the cavity of the skeleton. For example, as depicted in FIG. 15, if the small spindle 102 was used as the rewinding spindle, the connector base 109 of the small spindle 102 may be inserted into the cavity 113 on the top of the skeleton 105. This may attach the rewinding roll 501 to the skeleton 105.

In block 1702, the paper of the rewinding roll may be pushed down over the skeleton. For example, as depicted in FIG. 15, the paper of the rewinding roll 501 may be pushed down over the skeleton 105 until the ribs of the skeleton 105 have been covered with the paper from the rewinding roll 501. This may result in a paper shape 1501. The paper shape 1501 may be the product of covering any shaped shape skeleton 105 with paper from a rewinding roll 501 attached to the skeleton 105.

FIG. 16 depicts exemplary skeletons and an exemplary accessory connector for paper quilling. The skeleton 105 may come in a variety of shapes and sizes, as depicted in FIG. 16. Skeletons 105 of any shape may be turned into a paper shape 1501 with the rewinding roll 501, allowing for the creation of paper shapes 1501 of varying shapes and sizes.

An accessory connector 1601 may be made of any suitable material, and may include prongs for attaching accessories to the accessory connector 1601, and a flat base for allowing the accessory connector 1601 to be attached to the paper shape 1501 by being slipped under the paper covering the skeleton 105. For example, the accessory connector 1601 may have an arm shaped piece of plastic attached to the prongs, and then be slipped between the layers of paper of the paper shape 1501 to attach the arm shaped piece to the paper shape 1501.

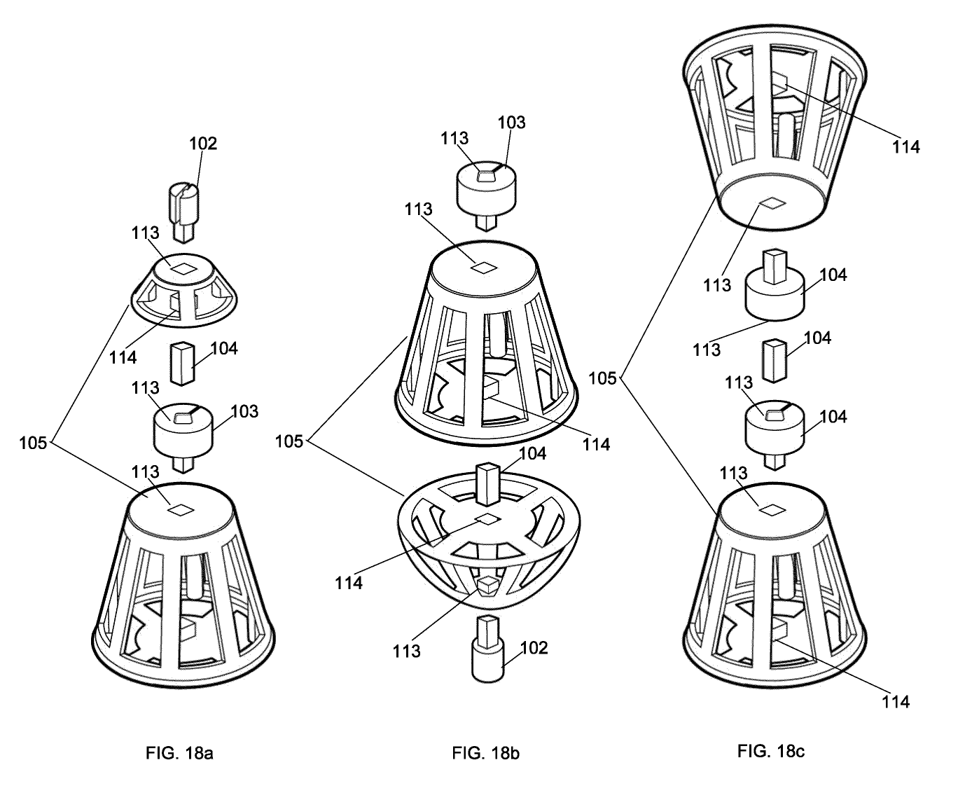

FIGS. 18a-c depicts exemplary connections between skeletons, spindles, and connectors. Various skeletons 105 may be attached to one another using spindles, such as the large spindle 103, and the connectors 104. For example, as depicted in FIG. 18a, a large spindle 103 may be connected to the cavity 113 on the top of a skeleton 105. A connector 104 may be connected to the cavity 113 on the large spindle 103. The connector 104 may also be connected to the bottom cavity 114 of a second skeleton 105. A small spindle 102 may be connected to the cavity 113 of the second skeleton 105.

As another example, as depicted in FIG. 18b, a small spindle 102 may be connected the cavity 113 on a skeleton 105. A connector 104 may be connected to the bottom cavity 114 on the skeleton 105, and the bottom cavity 114 on a second skeleton 105, causing the skeletons 105 to be joined at the base. A large spindle 103 may be connected to the cavity 113 on the second skeleton 105.

As another example, as depicted in FIG. 18c, a large spindle 103 may be connected the cavity 113 on a skeleton 105. A connector 104 may be connected to the cavity 113 on the large spindle 103. The cavity 113 of a second large spindle 103 may be connected to the other end of the connector 104. The cavity 113 of a second skeleton 105 may be connected to the second large spindle 103.

The skeletons 105 depicted in FIG. 18 are depicted without the paper covering to illustrate the connection between the skeletons 105. By covering the skeletons 105 with paper, as described above, to make the paper shapes 1501, the various manners of connecting the skeletons 105 may be used to create objects. The objects may be, for example, humanoid figures or animal figures, or they may be any other shape and be decorated in any manner.

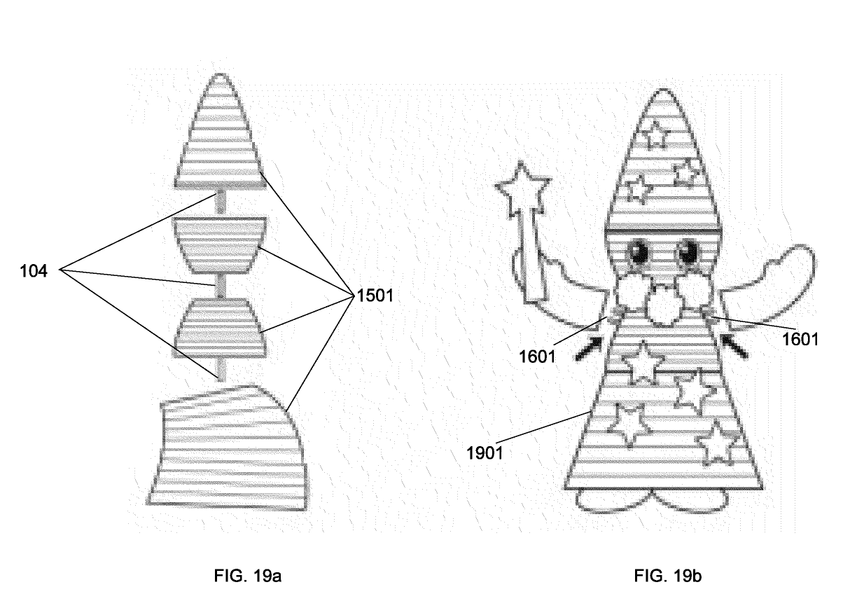

FIGS. 19a-b depict an exemplary figure constructed through the connection of paper shapes. As depicted in FIG. 19a, various paper shapes 1501, made with skeletons 105 of various shapes, may be connected together with several of the connectors 104. The paper shapes 1501 may vary in color depending on the paper used for the bulk roll 201 in the winding device 101 when creating the rewinding rolls 501 for the paper shapes 1501. The result of connecting the paper shapes 1501 together may be, as depicted in FIG. 19b, a humanoid FIG. 1901. The accessory connectors 1601 may be used to attach arms to the FIG. 1901. Glue or other adhesives may be used to attach other details and decorations to the FIG. 1901, including, for example, eyes, feet, clothing decorations, and other accessories.

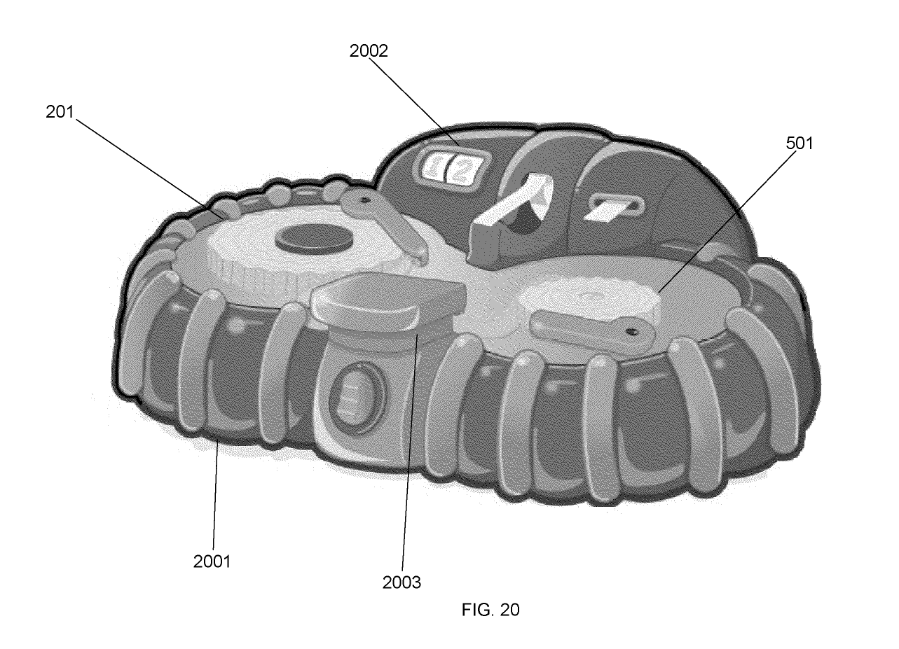

In another embodiment, the winding device 101 may be a mechanized device. FIG. 20 depicts an exemplary machine for paper quilling. The machine 2001 may be mechanized device for paper quilling that may perform the functions of the winding device 101, but may make use of a motor or other mechanized turning device to turn the cavity 108, in place of the manual turning done with the winding knob 107. Tension in the bulk roll 201 and the rewinding roll 501 may be maintained in the machine 2001 without the use of the rubber bands 502. Both the bulk roll 201 and the rewinding roll 501 may have spring operated supports which maintain a constant tension and avoid having the paper unravel at any stage.

As with the winding device 101, the bulk roll 201 may be placed on the fixed spindle 106, and a rewinding spindle, such as the small spindle 102, may be placed into the cavity 108. The end of the bulk roll 201 may be fed into the slot 110 on the rewinding spindle. A button or other input device may be used to turn on a motor in the machine 2001. The motor may cause the cavity 108 to rotate, which may rotate the rewinding spindle and cause paper to be transferred from the bulk roll 201 to the rewinding spindle, creating the rewinding roll 501. When the rewinding roll 501 has reached the desired size, the motor may be stopped.

A counter 2002 connected to the machine 2001 may count each turn, allowing for accurate size rewinding rolls 501 to be created. The counter 2002 may count each turn of the rewinding roll 501. The machine 2001 may include a ruler or other measuring markers on the surface to allow for the measurement of the diameter of the rewinding roll 501.

The machine 2001 may include a cutting and joining device 2003. The cutting and joining device 2003 may be used to cut the paper when the rewinding roll 501 has reached the desired size. The cutting and joining device 2003 may also be used to allow the tape 901 to be applied to the paper when the bulk roll 201 is replaced with another bulk roll 1201, for example, when adding a second color to the rewinding roll 501.

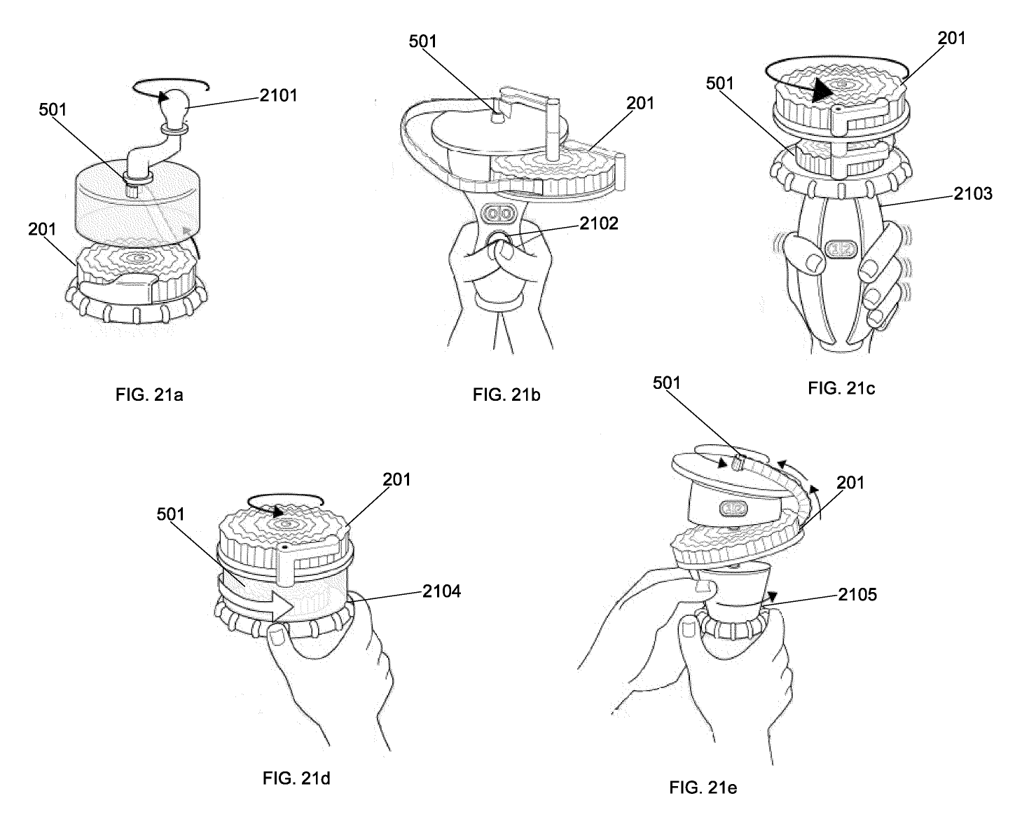

FIGS. 21a-e depict exemplary small machines for paper quilling. The small machines may operate similarly to the winding device 101, and may use differing placements of the bulk roll 201 and the rewinding roll 501 and different mechanisms for causing paper to rotate the rewinding spindle and cause paper to be transferred from the bulk roll 201 to the rewinding roll 501. For example, as depicted in FIG. 21a, the bulk roll 201 may be positioned underneath the rewinding roll 501, and paper may be transferred by rotating the rewinding roll 501 with a hand crank. As depicted in FIG. 21b, the bulk roll 201 may be positioned below and offset from the rewinding roll 501, and paper may be transferred by rotating the rewinding roll 501 with a motor 2102 operated by a button on the front of the small machine. As depicted in FIG. 21c, the bulk roll 201 may be positioned above the rewinding roll 501, and the paper may be transferred by rotating the rewinding roll 501 with a pump operated turning mechanism 2103. As depicted in FIG. 21d, the bulk roll 201 may be position above the rewinding roll 501, and the paper may be transferred by rotating the rewinding roll 501 using a base winding knob 2104 to rotate the rewinding roll 501. The base winding knob may be located at the bottom of the small machine. As depicted in FIG. 21e, the bulk roll 201 may be positioned below and angled toward the rewinding roll 501, which may be angled toward the bulk roll 201, and the paper may be transferred by turning a base winding knob 2105 to rotate the rewinding roll 501.

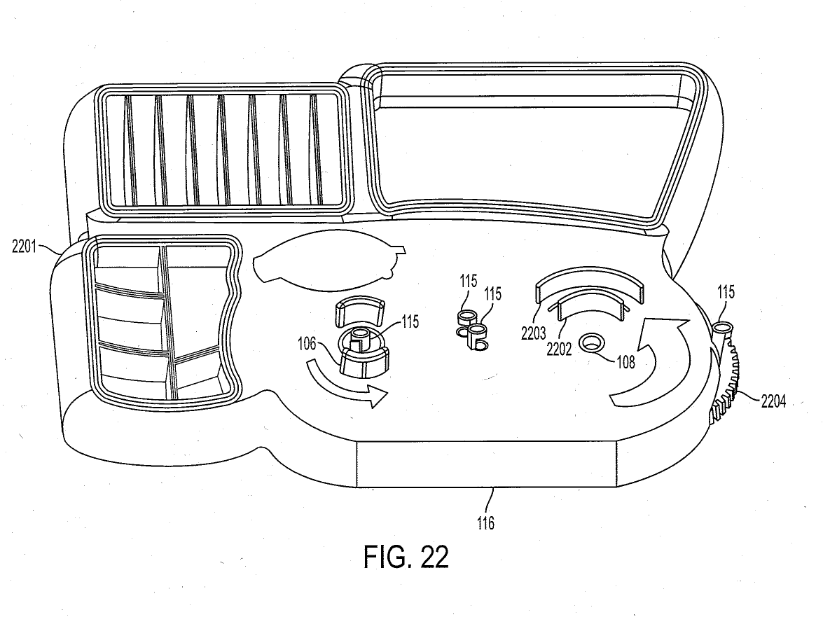

FIG. 22 depicts an exemplary large winding device for paper quilling. A large winding device 2201 for paper quilling may be similar to the winding device 101, but may be larger. For example, the body 116 of the large winding device 2201 may be a large tray. The large winding device 2201 may include plastic stopper 2202 and 2203 instead of size markings 702 and 703. The cavity 108 may be rotated by the large winding knob 2204 on the side of the large winding device 2201, instead of the using the winding knob 107 underneath the cavity 108 as in the winding device 101.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

What is claimed is:

1. A device for paper quilling comprising:
a turning device with a cavity;
a fixed spindle displaced from the turning device;
a rewinding spindle comprising a slot and a connector base, wherein the connector base is shaped to fit into the shaped cavity such that part of the rewinding spindle sits above the cavity and the rewinding spindle rotates when the turning device rotates.

2. The device of claim 1, wherein the fixed spindle is at least one of vertically and horizontally displaced from the turning device.

3. The device of claim 1, wherein the turning device is at least one of a winding knob, a hand crank, and a pump operated turning mechanism.

4. The device of claim 1, further comprising at least one rubber band holder.

5. The device of claim 4, wherein four rubber band holders are positioned to hold one rubber band over a bulk roll on the fixed spindle and one rubber band over a rewinding roll on the rewinding spindle.

6. The device of claim 1, wherein rotating the turning device causes paper to be transferred from a bulk roll on the fixed spindle to a rewinding roll on the rewinding spindle.

7. The device of claim 1, wherein the rewinding spindle is at least one of a small spindle and a large spindle.

8. The device of claim 7, wherein the large spindle comprises a shaped cavity.

9. The device of claim 1, wherein the turning device is a mechanized turning device.

10. The device of claim 1 further comprising a counter connected to the turning device.

11. The device of claim 1, further comprising a cutting and joining device.

12. A method of paper quilling comprising:
placing a bulk roll on a fixed spindle;
placing a rewinding spindle into a cavity connected to a turning mechanism;
feeding an end of the bulk roll into a slot on the rewinding spindle; and
rotating the turning mechanism causing paper from the bulk roll to wrap around the rewinding spindle forming a rewinding roll.

13. The method of claim 12, further comprising:
cutting the paper in between the bulk roll and the rewinding roll;
removing the bulk roll from the fixed spindle;
placing a new bulk roll on the fixed spindle;
taping an end of the new bulk roll to an end of the rewinding roll; and
rotating the turning mechanism.

14. The method of claim 12, further comprising:
placing a rubber band over the bulk roll; and
placing a rubber band over the rewinding roll.

15. A method of assembling rolled paper comprising:
connecting a connector base of a rewinding spindle in a rewinding roll to a cavity on a skeleton; and
pressing rolled paper of the rewinding roll down over the skeleton to form a paper shape.

16. The method of claim 15, further comprising:
connecting the paper shape to a second paper shape with a connector connected to a cavity of a skeleton or top of a large spindle and a cavity of a second skeleton or top of a second large spindle.

17. A winding device for paper quilling comprising:
a body;
a fixed spindle disposed on the body;
a grip disposed on the body on the other side of and below the fixed spindle; and
a winding knob with a cavity attached to the body and horizontally displaced from the fixed spindle with the cavity on the same side of the body as the fixed spindle and the winding knob on the same side of the body as the grip.

18. The winding device of claim 17, further comprising:
a rewinding spindle inserted into the cavity such that the rewinding spindle rotates when the winding knob is rotated.

19. The winding device of claim 17, further comprising four rubber band holders, wherein a first and second rubber band holder are disposed on the body such that a rubber band held between the first and second rubber holders will be above and apply tension to a bulk roll on the fixed spindle, and wherein a third and fourth rubber band holder are disposed on the body such that a rubber band held between the third and fourth rubber holders will be above and apply tension to rewinding roll on a rewinding spindle in the cavity.

20. A apparatus for assembling rolled paper comprising:
a skeleton comprising:
a base comprising a cavity;
a top comprising a second cavity; and
at least one rib connecting the base to the top.

21. The apparatus of claim 20, further comprising:
a large spindle comprising:
a connector base; and
a top comprising a cavity and a slot.

22. The apparatus of claim 21, further comprising:
a small spindle comprising:
a connector base; and
a top comprising a slot.
